(19) United States
(12) Patent Application Publication
(10) Pub. No.: US 2026/0043300 A1
(43) Pub. Date: Feb. 12, 2026

(54) ANTI-ROTATION APPARATUS AND METHOD AND A PIPE ASSEMBLY AND A SYSTEM HAVING SAME

(71) Applicant: Westlake Pipe & Fittings Corporation, Houston, TX (US)

(72) Inventors: George Ferguson, Wayne, PA (US); Joshua E. Clapper, Downingtown, PA (US); Thomas Soper, Wayne, PA (US); Roy L. Dean, Schwenksville, PA (US); Dmitry Yashin, Haverford, PA (US); Andrew Wells, Wayne, PA (US); Austin Bragg, Wayne, PA (US); Andrew Schlosser, Wayne, PA (US); Harrison Connors, Wayne, PA (US); Jake Hostrander, Wayne, PA (US)

(21) Appl. No.: 19/297,959

(22) Filed: Aug. 12, 2025

Related U.S. Application Data
(60) Provisional application No. 63/682,036, filed on Aug. 12, 2024.
(60) Provisional application No. 63/682,042, filed on Aug. 12, 2024.

(51) Int. Cl. E21B 17/046

(52) U.S. Cl. CPC E21B 17/0465

(57) ABSTRACT

An anti-rotation apparatus for a pipe joint includes: a stop piece having a body with a retaining portion and a locking part; a first joint part and a second joint part coupled to one another and having an axis in a lengthwise direction of the pipe joint; a locking receptacle provided in the first joint part; and a receiving receptacle provided in the second joint part. The retaining portion of the body of the stop piece is disposed in the receiving receptacle of the second joint part and the locking part protrudes in a radial direction relative to the axis. When the locking part and the locking receptacle are axially and rotationally aligned, and when the locking part is disposed in the locking receptacle of the first joint part, relative rotation about the axis between the first joint part and the second joint part is prevented.

### RELATED APPLICATION DATA

This patent is entitled to the benefit of and claims priority to co-pending U.S. Provisional Application Ser. Nos. 63/682,036 and 63/682,042, each filed Aug. 12, 2024, and each entitled “Anti-Rotation Apparatus and Method and a Pipe Assembly and a System Having Same.” The entire contents of these prior filed application are hereby incorporated herein by reference.

### BACKGROUND

### 1. Field of the Disclosure

The present disclosure is generally directed to pipe joints, and more particularly to an anti-rotation feature for a joint connecting pipe sections along a string of pipe.

### 2. Description of Related Art

Pipe formed from plastic material has become common for use in private residences, commercial facilities, and municipalities. Plastic pipe is often made from poly-vinyl chloride (PVC). Pipe sections are joined together at pipe joints to form extended lengths or a string of pipe for myriad uses. The pipe joints in some instances are fixed whereby the pipe sections and the pipe joints are plastic welded or permanently bonded together. However, in many installations and uses, the pipe sections are connected to one another using pipe joints whereby the pipes and joints are separable and/or movable relative to one another.

A typical pipe connection at a pipe joint in these types of pipe systems allows for some axial movement and rotation among the pipe sections and the pipe joints. In some applications, this is acceptable or even desired, particularly for pipe systems whereby the components are completely static. However, rotation among the pipe system components can be unfavorable or problematic for a large variety of piping applications, particularly where rotational forces may be applied to the string of pipe.

A primary example of such a system is known as a drop pipe system. A drop pipe system may extend down into the ground below the water table for pumping water to the surface. A pump is installed and connected at or near the bottom of the string of pipe. A power line or cable is run along the length of the pipe from a power source above ground down to the pump. During operation, the pump exerts a rotational force, i.e., torque to the pipe and can spin the pipe joints and/or the pipe sections relative to one another along the string of pipe. Over time, this can result in the power cable to the pump wrapping around the pipe and eventually disconnecting or splitting. Power loss to the pump will result once the cable is disconnected or splits or breaks.

### SUMMARY

In one embodiment according to the teachings of the present disclosure, an anti-rotation apparatus for a pipe joint includes: a stop piece having a body with a retaining portion and a locking part; a first joint part and a second joint part coupled to one another and having an axis in a lengthwise direction of the pipe joint; a locking receptacle provided in the first joint part; and a receiving receptacle provided in the second joint part. The retaining portion of the body of the stop piece is disposed in the receiving receptacle of the second joint part. The locking part protrudes in a radial direction relative to the axis. When the locking part and the locking receptacle are axially and rotationally aligned, and when the locking part is disposed in the locking receptacle of the first joint part, relative rotation about the axis between the first joint part and the second joint part is prevented.

In one embodiment, the first joint part can be a spigot end of a first pipe, the second joint part can be a belled end of a second pipe, the spigot end can be disposed in the belled end, and the axis can be a center axis of the first and second pipes.

In one embodiment, the receiving receptacle can be a blind bore in or a hole through a wall of the second joint part.

In one embodiment, the receiving receptacle can include a plurality of blind holes in or holes through a wall of the second joint part. The plurality of blind holes or through holes can be spaced apart from one another circumferentially about the axis.

In one embodiment, the plurality of blind holes or through holes is spaced apart equidistant from one another on the second joint part.

In one embodiment, the locking receptacle can be a locking groove in an outer wall of the first joint part.

In one embodiment, the locking receptacle or locking groove can have a finite length and can extend in a circumferential direction on the first joint part. The finite length can be adequate to receive the locking part of the stop piece therein.

In one embodiment, the locking receptacle can include a plurality of the locking grooves arranged circumferentially around the first joint part.

In one embodiment, the body of the stop piece can include: a base having a base length across the stop piece between opposed ends, at least a portion of the base defining the locking part; and can include a loop portion protruding from a top surface of the base, at least part of the loop portion defining the retaining portion.

In one embodiment, the loop portion can define and surround an open center within the loop portion. The loop portion can define a pair of retention ears at a free end of the loop portion spaced from the base. The loop portion can have a first width across the retention ears of the loop portion and the first width can be less than the base length. The loop portion can have a midsection between the base and the pair of retention ears. The loop portion can have a second width across the dissection and the second width can be less than the first width.

In one embodiment, the loop portion can be resiliently flexible.

In one embodiment, the receiving receptacle can include a hole through a wall of the second joint part. A dual depth recess can be provided in the wall on each side of the hole in the circumferential direction. The locking part can be movable in a radial direction relative to the axis according to the dual depth recess.

In one embodiment, the body of the stop piece can include: a housing containing a biasing element therein, the housing defining at least part of the retaining portion; and a pin resiliently biased to protrude from the housing, the pin being retractable into the housing and defining at last a portion of the locking part.

In one embodiment, the first joint part can be a spigot end of a first pipe, the second joint part can be a coupler with an opening configured to receive the spigot end of the first pipe, the spigot end can be disposed in the opening, and the axis can be a center axis of the first pipe and the coupler.

In one embodiment according to the teachings of the present disclosure, a method is disclosed of forming a pipe joint having an anti-rotation feature and an axis. The method includes providing a first joint part having one or more locking receptacles formed in the first joint part. The method also includes installing a retaining portion of a body of a stop piece into a receiving receptacle of a second joint part, whereby a locking part of the body protrudes inward from an inner surface of the second joint part in a radial direction. The method further includes inserting the first joint part into the second joint part. When the locking part is not yet engaged with the any of the one or more locking receptacles, the method includes facilitating rotation of the first joint part and the second joint part relative to one another until the locking part axially and rotationally aligns with and engages one of the one or more locking receptacles, thereby preventing relative rotation about the axis between the first joint part and the second joint part.

In one embodiment, the body of the stop piece can include: a base having a base length across the stop piece between opposed ends, at least a portion of the base defining the locking part; and a loop portion protruding from the base, at least part of the loop portion defining the retaining portion. In the method, the step of installing can include installing the loop portion through the receiving receptacle, and the step of inserting can include the outer surface of the first joint part forcing the locking part radially outward within the receiving receptacle. The method can also include placing the first joint part and the second joint part under tension, causing the locking part of the stop piece to engage the locking receptacle.

In one embodiment according to the teachings of the present disclosure, a pipe joint assembly includes: a first pipe having a first pipe first end and a first pipe second end, the first pipe first end defining a spigot end of the first pipe; a second pipe having a second pipe first end and a second pipe second end, the second pipe second end defining a belled end of the second pipe, the spigot end of the first pipe inserted into the belled end of the second pipe; and an anti-rotation apparatus configured to prevent relative rotation between the first pipe and the second pipe. The anti-rotation apparatus includes a stop piece installed in a radial direction in a wall of the belled end of the second pipe. A locking part of the stop piece is received in a locking receptacle in an outer surface of a wall of the spigot end of the first pipe.

In one embodiment, the body of the stop piece can include: a base having a base length across the stop piece between opposed ends, at least a portion of the base defining the locking part; and a loop portion protruding from a top surface of the base, at least part of the loop portion defining the retaining portion.

In one embodiment according to the teachings of the present disclosure, a drop pipe system includes a pump configured to be installed below ground and at least one power cord configured to extend from above ground level to the pump below ground level and to deliver power for operating the pump. The system also includes a pipe string including a plurality of pipes. The pipe string has one end connected to the pump and another end accessible near ground level. The system further includes a first pipe of the plurality of pipes having a first pipe first end and a first pipe second end and includes a second pipe of the plurality of pipes having a second pipe first end and a second pipe second end. The first pipe first end is connected to the second pipe second end to form a pipe joint. An anti-rotation apparatus at the pipe joint is configured to prevent relative rotation between the first pipe and the second pipe when the pump is operated. The anti-rotation apparatus includes a stop piece installed in a radial direction in a wall of the pipe joint. A locking part of the stop piece is received in a locking receptacle in an outer surface of another wall of the pipe joint.

In one embodiment, the pipe joint system can further include a coupler between and connecting the first pipe first end to the second pipe second end.

### BRIEF DESCRIPTION OF THE DRAWINGS

The drawings provided herewith illustrate examples or embodiments of the disclosure and therefore should not be considered as limiting the scope of the disclosure. There may be other examples and embodiments that may be equally effective to achieve the objectives and that may fall within the scope of the disclosure. Objects, features, and advantages of the present disclosure should become apparent to those having ordinary skill in the art upon reading the following description in conjunction with the drawing figures, in which:

FIG. 1 shows a generic schematic view of a drop pipe system for which the anti-rotation aspects of the present disclosure are well suited.

FIG. 2 shows an exploded perspective view of one embodiment of a pipe joint assembly with an anti-rotation apparatus according to the teachings of the present disclosure.

FIG. 3 shows a partially exploded perspective view of the pipe joint assembly of FIG. 1 and prior to assembly of the joint.

FIG. 4 shows a lengthwise perspective view and partial cross section of the pipe joint assembly of FIG. 3.

FIGS. 5A-5C show various views of one embodiment of an anti-rotation stop or insert piece according to the teachings of the present disclosure and for the pipe joint assembly of FIGS. 2-4.

FIG. 6 shows a cross-section of a belled end of a first pipe of the pipe joint assembly of FIG. 2.

FIG. 7 shows an enlarged view of a portion of the belled end of the first pipe of FIG. 5.

FIG. 8 shows a cross-section of the unassembled pipe joint assembly of FIG. 3.

FIG. 9 shows the pipe joint assembly of FIG. 8 but during assembly of the joint.

FIG. 10 shows the pipe joint assembly FIGS. 8 and 9 with the pipe joint fully assembled but the joint parts under compression and with the anti-rotation apparatus unlocked.

FIG. 11 shows the pipe joint assembly of FIG. 10 but with the fully assembled pipe joint assembly under tension and the anti-rotation apparatus locked.

FIG. 12 shows a perspective view, partially cut away, of the pipe joint assembly of FIGS. 10 and 11 according to the teachings of the present disclosure.

FIG. 13 shows an exploded perspective view of another embodiment of a pipe joint assembly according to the teachings of the present disclosure and with the ani-rotation stop or insert piece of FIGS. 5A-5C.

FIG. 14 shows a perspective view of the pipe joint assembly of FIG. 13 but fully assembled.

FIG. 15 shows an exploded perspective view of another embodiment of a pipe joint assembly with an anti-rotation apparatus according to the teachings of the present disclosure.

FIG. 16 shows a partially exploded perspective view of the pipe joint assembly of FIG. 15 and prior to assembly of the joint.

FIG. 17 shows a lengthwise perspective view and partial cross section of the pipe joint assembly of FIG. 16.

FIGS. 18A-18D show various views of one embodiment of an anti-rotation stop or insert piece according to the teachings of the present disclosure and for the pipe joint assembly of FIGS. 15-17.

FIG. 19 shows a cross-section of the unassembled pipe joint assembly of FIG. 16.

FIG. 20 shows the pipe joint assembly of FIG. 19 but during assembly of the joint.

FIG. 21 shows the pipe joint assembly FIG. 20 but with the joint fully assembled and the anti-rotation apparatus locked.

FIG. 22 shows a perspective view, partially cut away, of the pipe joint assembly of FIG. 21 according to the teachings of the present disclosure.

FIG. 23 shows an exploded perspective view of another embodiment of a pipe joint assembly according to the teachings of the present disclosure and with the ani-rotation stop or insert piece of FIGS. 18A-18D.

FIG. 24 shows a perspective view of the pipe joint assembly of FIG. 23 but fully assembled.

FIGS. 25-27 show perspective views of yet another embodiment of a pipe joint assembly with an anti-rotation apparatus according to the teachings of the present disclosure.

The use of the same reference numbers or characters throughout the written description and drawings indicates similar or identical components, aspects, and features of the disclosure.

### DETAILED DESCRIPTION OF THE DISCLOSURE

An aspect of the present disclosure is to solve or improve upon one or more of the above-noted problems with prior known pipes and pipe joints. According to the embodiments of the present disclosure, a separate component, device, feature, or the like, i.e., the anti-rotation stop or insert piece is incorporated in a pipe joint. In the disclosed embodiments, the insert or stop piece is incorporated in a female end, i.e., in a belled end of a pipe or in a pipe coupler or pipe joint. The insert or stop piece may be recessed or otherwise incorporated in the female end or the coupler in a manner to allow for insertion of a male end, i.e., a spigot end, of a pipe into another pipe or a coupler of the pipe joint.

In the disclosed embodiments, either in the correct rotational orientation or during initial allowable rotation of the pipe, the insert or stop piece is configured to automatically engage with one or multiple features on the male end of the pipe that is joined to the female end in order to prevent further rotation. The disclosed solutions function independently of features of the pipe that counteract tension in the pipe joint, allowing for disassembly of the pipe joint as desired. For each of the disclosed embodiments, the size and shape of the insert or stop piece may be varied based on torque requirements and/or other aspects of a given application.

The specification does not necessarily describe all elements of various embodiments of the present disclosure. Descriptions of elements or components well-known in the art to which the present disclosure pertains or overlapping or repetitive descriptions have been entirely or partly omitted.

It should be understood that, when an element is referred to as being “connected” to another element, it can be directly or indirectly connected to the other element. An indirect connection includes one or more intervening elements or parts among or between two connected elements.

It should be understood that the terms “include,” “comprise,” “have,” and the like, and variations thereof, when used in the present disclosure, specify the presence of stated features, integers, steps, operations, elements, and/or components. The terms do not preclude the presence or addition of one or more other features, integers, steps, operations, elements, components, and/or groups thereof.

It should be understood that, where it is stated in the present disclosure that an element is located “on” another element, the element may be in direct contact with the other element, or another element may yet be present between the one element “on” the other element.

It should be understood that, although the terms first, second, etc., and other such similar terms may be used herein to describe various elements, these elements should not be limited by these terms. These types of terms are used merely to distinguish among various elements, unless expressly stated to the contrary. Similarly, terms such as “up,” “upward,” “vertical,” “down,” “downward,” “forward,” “rearward,” “horizontal,” “lateral,” and the like, if used herein, are used for reference as relative directional terms. It should be understood that these types of terms are also not strictly limiting, unless expressly stated herein.

It should be understood that the use of singular forms is intended to include the plural forms as well unless the context clearly dictates otherwise. Further, when a component, device, element, or the like of the present disclosure is described as having a purpose or performing an operation, function, or the like, the component, device, or element should be considered herein as being “configured to” meet that purpose or perform that operation or function.

Reference numerals, which may be used for method steps, are used for convenience of explanation, but not to limit an order of the steps. Thus, unless the context clearly dictates otherwise, the written order may be practiced otherwise.

Hereinafter, an operation principle and embodiments of the present disclosure are described in detail with reference to the accompanying drawings. In each embodiment, the pipe joint assembly includes a coupling or pipe joint that joins and interlocks two pipes or pipe sections to one another. Though not described in detail herein, the coupling or pipe joint may include a separate coupler that connects two pipes together and each connection between a pipe and the coupler may be configured as described herein. However, in the disclosed embodiments, each coupling or joint is a direct connection between two adjacent pipes or pipe sections. Aspects of the present disclosure and the embodiments described herein are described as being suitable for use in a drop pipe system. However, as should be apparent to those having ordinary skill in the art, the ani-rotation concepts can be used for other pipe joints and pipe systems as well.

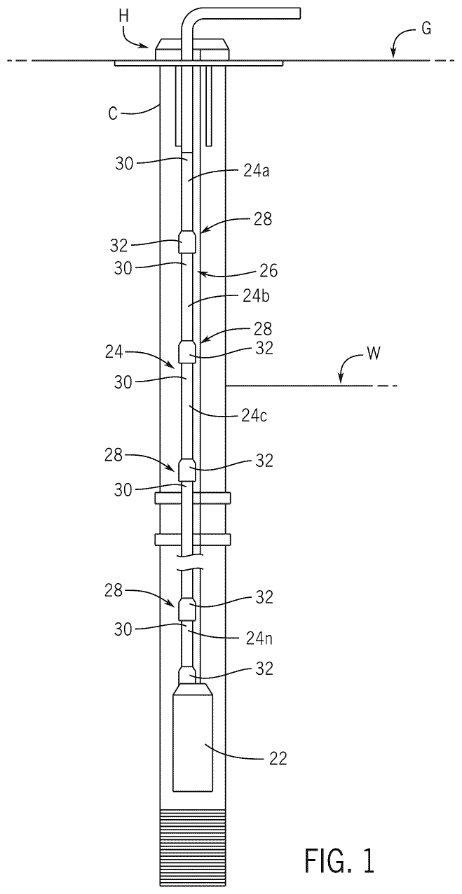

In the context of the present disclosure, and as shown in FIG. 1, a drop pipe system 20, such as for a well, has a pump 22 that is configured to be installed below ground level G, at the lower or bottom end of a drop pipe assembly or pipe string 24. The pipe string 24 and pump 22 may be received in an outer casing, such as a well casing C that keeps the surrounding ground from collapsing on the pipe string and allows ground water to reside around the pipe string up to the water table level W. The pump 22 is configured to pump fluid, such as water, from below up to ground level G or above. The system 20 has at least one power cord 26 that extends from a power source (not shown), such as a source of electricity, to the pump 22 below ground level G. The cord 26 delivers or provides power for operating the pump 22. The pipe string 24 of the system 20 may typically have a series of pipes, i.e., pipe sections or segments, which are connected end to end to form the drop pipe assembly or pipe string 24. The pipe string 24 connects the pump 22 to a part or structure (not shown) at a point, such as at a well head H, above ground level G where the water or fluid can be collected, stored, and distributed. The pipe string 24 has pipe joints 28 where each adjacent two pipes are connected to one another.

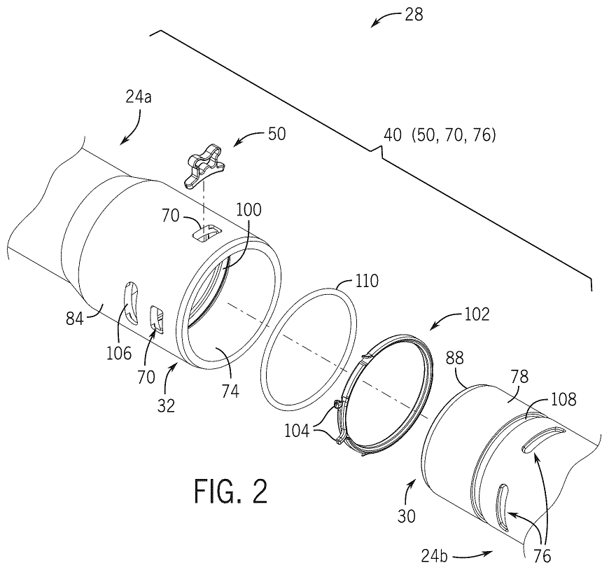

Thus, referring to FIGS. 1 and 2, the system 20 may be described as having at least a first pipe section or segment, i.e., a first pipe 24a, that has a first pipe first end 30 and a first pipe second end 32 opposite the first end. For the sake of description, the first end 30 of the first pipe 24a may be a male or spigot end of the pipe and the second end 32 of the first pipe may be a female or belled end of the pipe. However, in a particular application or use environment, this may be reversed, depending on how the pipe may attach to the pump 22, to a component C (shown only generically) at the well head H, or based on other pipe or system considerations. In this embodiment, the component C at the well head H of the system 20, near or above ground level G, may be connected or connectable to the first end 30 of the first pipe 24a in any known manner. The system 20 also has at least a second pipe section or segment, i.e., a second pipe 24b that has a second pipe first end 30 and a second pipe second end 32. The second pipe first end 30 is connected or connectable to the second end 32 of the first pipe 24a and thus, in this embodiment, the first end may be a male or spigot end of the second pipe. Likewise, the second end 32 of the second pipe 24b may again be a female or belled end of the second pipe. The second pipe second end 32 is connected or connectable to a first end 30 of yet another pipe, i.e., a third pipe 24c or alternatively to the pump 22 in a known manner at the bottom of the pipe string 24.

The system 20 may include any number of additional pipe sections or segments ‘n’, i.e., additional pipes 24c-24n that are connected to one another to form the pipe string 24. The number of pipes ‘n’ can vary widely depending on the length or depth of the pipe system or drop pipe system, the system requirements, the length of each pipe section or segment, and/or the like. The system 20 also may have separate couplers (not shown or described herein) that are configured to join adjacent pipe sections or segments to one another at each joint 28, thus defining a separate joint between each pipe and the coupler, instead of directly between two pipes. In the disclosed embodiments, the pipe joints 28 or couplings are formed by directly inserting a spigot end of one pipe section or segment, i.e., the first end 30 of the second pipe 24b into a belled end, i.e., the second end 32 of the first pipe 24a, without the use of a separate coupler.

According to the teachings of the present disclosure, the system 20 also has an anti-rotation apparatus at the pipe joints 28. The pipe joints 28 may include each joint between any two adjacent two pipes, a joint between a pipe and the pump 22, and/or a joint between a pipe and another component of the system, such as the component C at the well head end H of the system 20. The anti-rotation apparatus is configured to prevent relative rotation at each joint between pipes and/or or between a pipe and another part of the system, such as the pump or another component. This relative rotation can occur when the pump 22 is operated or when a torque is applied to the pipe string 24. The anti-rotation apparatus is shown and described herein at the joint 28 between the first pipe 24a and the second pipe 24b, though the apparatus can be used at any of the aforementioned joints or couplings. The anti-rotation apparatus generally includes an anti-rotation stop or insert piece and includes features provided on the joined pipe components, such as on the first pipe 24a and second pipe 24b, that accommodate and/or interact with the stop piece to prevent relative rotation between the joined parts. In the disclosed embodiments, the anti-rotation stop or insert piece is installed in a radial direction through at least a portion of the parts of the coupling or pipe joint 28 to rotationally interlock the first pipe 24a relative to the second pipe 24b. This anti-rotation apparatus addresses the above-described problems with prior art drop pipe and other pipe systems.

In the context of the present disclosure, the anti-rotation apparatus is provided for a pipe joint 28, which can be between the first pipe 24a and a structure, such as the component C, at the well head H near ground level G, between two pipes 24a and 24b, or between a last pipe ‘n’ and the pump 22 at the bottom free end of the pipe string 24 opposite the well head. The apparatus includes the anti-rotation stop or insert piece, which may have a body and a locking part. The anti-rotation apparatus may also be considered to include or to be incorporated into a coupling or pipe joint. The coupling or pipe joint may include a first joint part, such as a first pipe, and a second joint part, such as a second pipe, with an axis in a lengthwise direction of the coupling. The anti-rotation apparatus may also include a receiving receptacle provided in the first joint part of the coupling and a locking receptacle provided in the second joint part of the coupling. The body or a part of the body of the anti-rotation stop piece may be disposed in the receiving receptacle of the first joint part. The locking part may protrude in a radial direction relative to the axis and, when in a locked or engaged arrangement, may be disposed in the locking receptacle of the second joint part thereby preventing relative rotation about the axis between the first and second joint parts.

Referring to FIGS. 2-5C, one embodiment of an anti-rotation apparatus 40 for a pipe joint 28 is shown. In this embodiment, the anti-rotation apparatus 40 includes a stop piece 50 or insert piece. The stop piece 50 may be made of stiff but resilient plastic or plastic-type material but other suitable materials may also be utilized. The stop piece 50 may be a single molded piece with a number of integrated features. Though only one stop piece 50 is shown and described for this embodiment, more than one stop piece may be utilized. Also, more than one retainer receptacle and/or locking receptacle can also be provided and used.

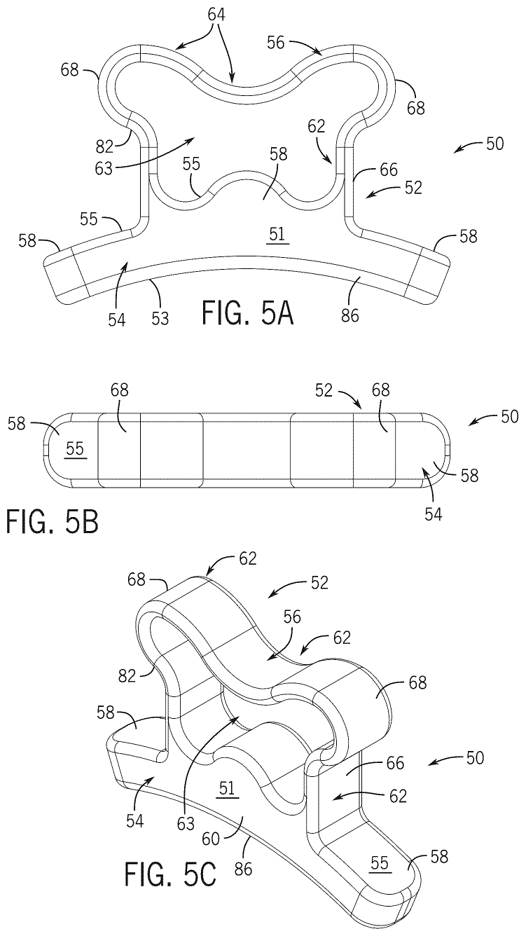

In this embodiment, as shown in FIGS. 5A-5C, the stop piece 50 has a body 52 that has a base portion or base 54 and a complex shaped flexible loop portion 56 connected to the base. In this embodiment, the base 54, i.e., a locking part, of the body 52 is generally rectangular in cross-section shape and has a pair of opposed side surfaces 51, a bottom surface 53, and a top surface 55. The base 54 can be a solid part and, in this embodiment, has a curved elongate shape with a width between the side surfaces 51. The base 54 has free opposed ends, which define extensions or feet 58 that extend or protrude outward in opposite directions beyond the extent of a central or middle portion 60 of the base. The base 54 has a length between the opposed ends of feet 58. The length or size of the central portion 60 coincides with a width of an integrated or proximal end 62 of the loop portion 56 that is adjacent and integrally connected to the base 54. A height or thickness of the base 54 between the bottom surface 53 and top surface 55 is greater in the central portion 60 and lesser in the region of the extensions or feet 58 and thus defines a beam or wall portion that coincides with the mid-section of the base and proximal end 62 of the loop portion. This can add compression strength across the loop portion 56 nearer the top surface 55 of the base 54.

In this embodiment, the loop portion 56, i.e., a retaining portion of the body 52, surrounds or defines an open middle portion 63 and has a free or distal end 64 opposite the proximal end 62 and base 54. The loop portion 56 also had a mid-section 66 between the free end 64 and the proximal end 62 and base 54. The free end 64 defines a pair of curved cars, i.e., retention cars 68 that protrude upward and outward in opposite directions relative to one another. The retention cars 68, together, extend wider than the width of the mid-section 66 and the proximal end 62, but not as wide as a width of the base 54 between the extensions or feet 58. The loop portion 56 of the stop piece 50 is flexible and resilient for insertion and removal, as described below. The retention ears 68 on the loop portion 56 are configured to retain the stop piece 50 on the female end of the pipe or coupling, once installed. Once installed, the stop piece 50 in this embodiment floats freely when uninterrupted or at rest.

The foregoing described geometric features and aspects of the stop piece 50 may be modified or altered within the spirit and scope of this disclosure. The shape of the base as well as the loop portion can be varied while still functioning as intended. The stop piece 50, including the loop portion 56 and the base 54 of the body 52, is relatively stiff but is sufficiently flexible and resilient to function as intended and as described herein. The stop piece 50 is configured to be resilient to allow for installing the stop piece in the pipe joint, retaining the stop piece in the installed arrangement, and removing the stop piece, if desired.

The various dimensions and shapes of the loop portion 56 and the base 54 may vary, as long as the base is stiff enough and the loop portion is sufficiently resilient to perform their intended function, as described below. The base curvature can vary to accommodate a particular pipe diameter dimension. The base height and length can vary, depending on the pipe sizes and strength requirements of a given application and use environment. Similarly, the size and shape of the retention ears can also vary. The height and width across the stop piece of the mid-section 66 of the loop portion 56 can also vary.

With reference to FIGS. 2-4, 6, and 7, the anti-rotation apparatus 40 also includes a receiving receptacle in one of the joint parts for installing or receiving one of the stop pieces. In this embodiment, the first joint part is the female end or belled end, i.e., the second end 32 of the pipe 24a. In this embodiment, the receiving receptacle is provided in the form of one or more apertures, windows, through openings, i.e., holes 70 through the wall of the pipe 24a for receiving the loop portion 56 of the stop piece 50. Also in this embodiment, each hole 70 is generally rectangular in shape and is sized in the axial direction of the pipe 24a, i.e., the hole width, to be larger than a width or depth of the body 52 of the stop piece for reasons discussed below. Further, the size of each hole 70 in the circumferential direction of the pipe 24a, i.e., the hole width, is smaller than the width across the retention cars 68 part of the loop portion 56. If more than one stop piece 50 is used, or if more than one installation location option is desired for each (one or more) stop piece, the female end 32 of the pipe 24a can include multiple receiving receptacles, i.e., multiple holes 70 around the pipe 24a circumference, as shown. For the anti-rotation function, however, only one stop piece 50 and one hole 70 need be provided.

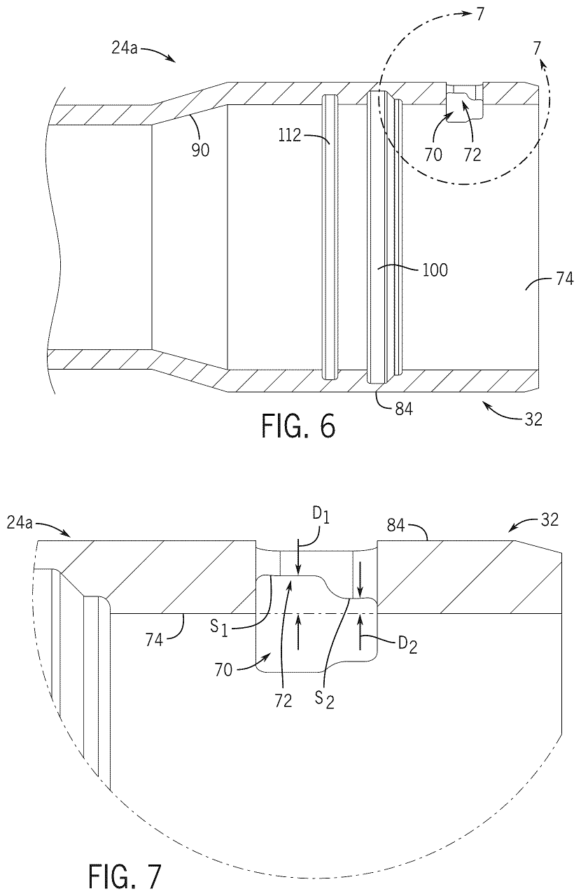

The anti-rotation apparatus 40, and more specifically, the receiving receptacle, i.e., the hole or holes 70 each also include a recess or groove 72 that is formed along the inner surface 74 of the same one of the joint parts that has the receiving receptacle for the stop piece. In this embodiment, the first joint part is again the female or belled end, i.e., the second end 32 of the first pipe 24a. As shown in FIGS. 6 and 7, the recess or groove 72 is formed in the inner surface 74 adjacent each end of the corresponding hole 70 in the circumferential direction. The recess 72 thus results in the wall thickness of the first pipe 24a being thinner, from the inner surface 74, than the surrounding wall thickness adjacent or next to each hole 70 in the circumferential direction. The recess or groove 72 also has a dual depth including a first recess surface S1 at a depth D1 and a second recess surface S2 at a depth D2. The deeper surface S1 is positioned further axially inward into the belled end or second end 32 of the first pipe 24a than the shallower surface S2. The extensions or feet 58 of the body 52 interact with these variable depth recesses 72 while the loop portion 56 extends through the hole 70. The variable depth of the recess 72 is provided so that the extension or feet 58 of the stop piece 50, and thus the bae 54 can seat within the recess and the hole 70 to the degree or depth needed either to allow formation of the pipe joint 28 (depth D1 and deeper surface S1), as described below, or to cause engagement of the base 54 of the stop piece 50 with the male end 30 or spigot of the second pipe 24b (depth D2 and shallower surface S1) to prevent rotation, also as described below.

The recess or groove 72 is provided to allow the stop piece 50 to move radially to facilitate assembly of a pipe joint 28, as described below. The recess or groove 72 may be formed as a pair of local recesses, respectively formed at the circumferential ends of each hole 70, and only to coincide with the circumferential position and axial location of the respective hole 70, as in this embodiment. Alternatively, the recess or groove 72 may be formed as a groove, to extend completely circumferentially around the inner surface 74 of the pipe wall, except through the hole(s) 70. A dimension or width (in the pipe axial direction) of each recess or groove 72 may match that of the hole(s) 70, as best shown in FIG. 7. The depth D1 into the inner surface 74 of the recess or groove 72 is such that the base 54 of the body 52 of the stop piece 50 can be moved radially outward into the recess or groove to the degree needed to allow formation of the pipe joint 28, as described below.

Referring to FIGS. 2-4 and 12, the anti-rotation apparatus 40 further includes a locking receptacle that is formed on the other of the joint parts and that interacts with the stop piece to prevent relative rotation between the joint parts. In this embodiment, the other joint part is the male or spigot end, i.e., the first end 30 of the second pipe 24b. In this embodiment, the locking receptacle is provided in the form of one or more blind slots or grooves, i.e., locking grooves 76 formed along an outer surface 78 of the spigot or male end, i.e., the first end 30 of the second pipe 24b. Each blind locking groove 76 is recessed into the outer surface 78 of the second pipe 24b and is formed to extend in a widthwise or circumferential direction around the second pipe 24b. The length of the locking groove or grooves 76 is sufficient to accommodate the length of the locking part, i.e., the base 54 of the stop piece 50. Further, the depth of the locking groove or grooves 76 is adequate enough to receive at least a portion of a height of the base 54 that is sufficient to perform the anti-rotation locking function described herein. In this embodiment, the stop piece 50 and the locking grooves 76 are oriented to extend widthwise or in the circumferential direction about the axis of the pipes 24a and 24b and the joint 28. Thus, the base 54 of the stop piece is curved to generally match the curvature of the pipe cylinder shape.

In one embodiment, one stop piece 50 and one locking groove 76 may be provided in a given anti-rotation apparatus. In another embodiment, one stop piece 50 and multiple locking grooves 76 may be provided. In yet another embodiment, two or more locking pieces 50 and at least two or more locking grooves 76 may be provided. If two or more locking grooves 76 are provided on the pipe 24b, the grooves 76 may be spaced apart in a circumferential direction around the pipe and may be spaced equidistant from one another around the pipe circumference. With more than one locking groove 76 per stop piece 50, more than one anti-rotation landing spot is provided. This will require less rotation between the female or belled end 32 and the male or spigot end 30 during installation or assembly of the pipe joint 28 before a stop piece 50 engages one of the locking grooves 76 to rotationally lock the two joint parts together. In one embodiment, if four locking grooves 76 are provided circumferentially and equidistant around the circumference of the pipe 24b, less than 90 degrees of relative rotation between the two pipes 24a and 24b is required to engage the anti-rotation apparatus 40.

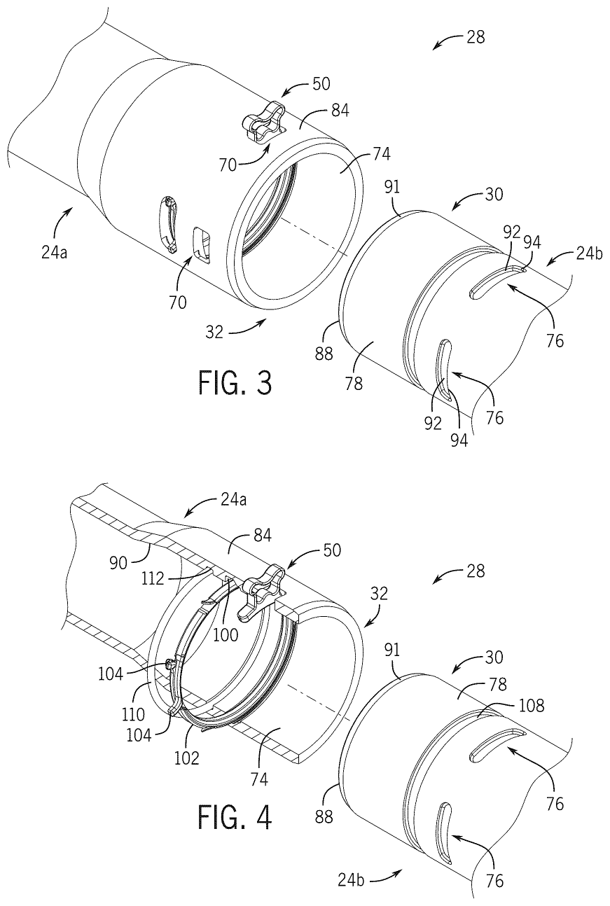

In this embodiment, the stop piece is installed in one of the pipe joints and then the anti-rotation feature will automatically lock upon rotation of one joint part relative to the other joint part. Referring to FIGS. 2-7, the stop piece 50 is first installed by inserting the loop portion 56 through the hole 70 or one of the holes 70 from the inside of the second end 32 of the first pipe 24a. The stop piece 50 should “snap” or “pop” into place through the hole 70 via resiliency of the loop portion, and particularly, the retention cars 68. In this embodiment, the retention cars 68 can move or be squeezed toward one another as the loop portion 56 clears the pipe material within the hole 70. The mid-section 66 of the loop portion 56 of the stop piece 50 seats in the opening of the hole 70 with the retention cars 68 positioned outside the belled female end or second end 32 and the base 54 and feet 58 positioned inside the female end. See FIGS. 3, 4, and 8. The retention cars 68 define a width across the loop portion 56 that is larger than the circumferential width of the hole 70. An outward and downward facing retention face 82 of the retention cars 68 bear against an outer surface 84 of the second end 32 on the first pipe 24a at the edges of the hole 70. Thus, once installed, the retention cars 68 will retain the stop piece 50 in place by preventing the loop portion 56 from free falling or being pushed back through the hole 70. If one wanted to remove the stop piece 50, the retention cars 68 could be squeezed toward one another to provide clearance for the loop portion 56 to pass in a reverse direction back through the holes 70.

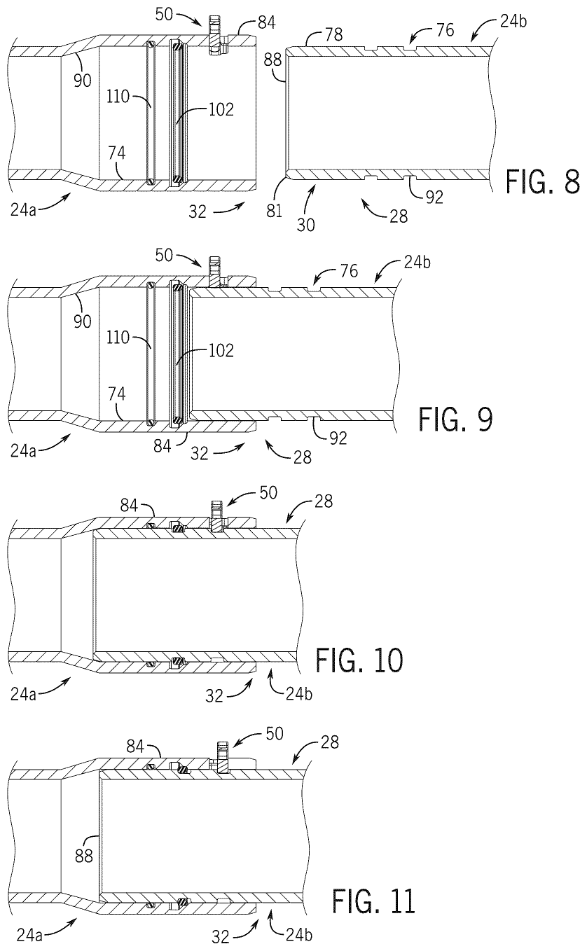

Referring to FIGS. 8-12, the pipe joint 28 is assembled by inserting the male or spigot end, i.e., the first end 30 of the second pipe 24b into the female or belled end, i.e., the second end 32 of the first pipe 24a. Sec FIGS. 8 and 9. The stop piece 50, such as the lengthwise bottom edges 86 at the bottom surface 53 and sides 51 of the base 54 on the body 52, and/or a leading end 88 of the spigot or male end, i.e., the first end 30 of the second pipe 24b may be ramped or chamfered. This can allow the first pipe 24a to readily push the stop piece 50 axially into the deeper part D1 of the recesses or grooves 72 adjacent the hole 70 and then radially outward against the deeper recess surface S1. In this position, the spigot or male end 30 of the pipe 24b can pass the stop piece 50 during pipe insertion. See FIGS. 5A, 6, and 7. When outward radial force is applied to the base 54 of the stop piece 50 via the outer surface 78 of the second pipe 24b, the base 54 is pushed radially outward such that the feet 58 are respectively received in the corresponding recess or groove 72 in the inner surface 74 of the pipe 24b at each side of the hole 70. This allows the second pipe 24b to be fully received in the first pipe 24a, such as is shown in FIGS. 10 and 11.

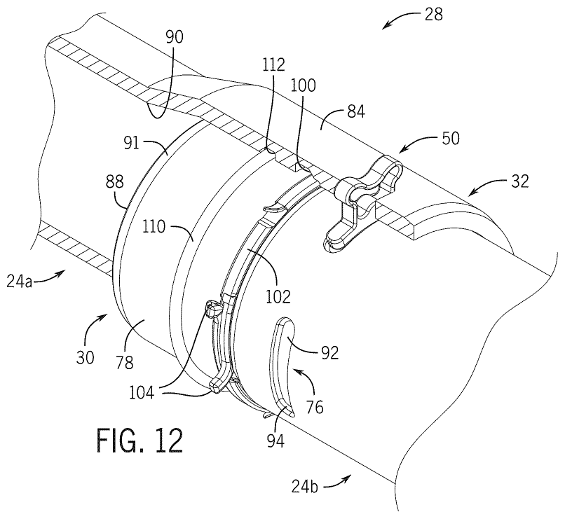

This also aligns the one or more locking grooves 76 on the outer surface 78 of the second pipe 24b with the one or more stop pieces 50 in the axial direction. Thus, the anti-rotation apparatus 40 is ready to engage, though the one or more locking grooves 76 are likely still mis-aligned rotationally with the one or more stop pieces 50. The axial insertion amount of the second pipe 24b into the first pipe 24a can be designed to automatically set and axially align the parts of the anti-rotation apparatus. This can be achieved by a precise length of the spigot end or first end 30 of the second pipe 24b being received in the belled end or second end 32 of the first pipe 24a before hitting a stop 90. In this embodiment, the stop 90 is created by the location at which the diameter defined by the inner surface 74 of the belled end or second end 32 of the first pipe 24a decreases to the nominal pipe diameter beyond the bell. See FIGS. 11 and 12.

As noted above, when the first end 30 of the second pipe 24b is fully inserted into the second end 32 of the first pipe 24a, as in FIG. 10, it is still likely that the one or more locking grooves 76 and the one or more stop pieces 50 are not rotationally aligned. Thus, the stop piece 50 would still be pushed into the deeper part D1 against the deeper groove surface S1 of the recess or groove 72, as depicted in FIG. 9. The first and second pipes 24a and 24b can then be rotated about the pipe axis relative to one another. This can be done manually at the time of assembling the pipe joint 28. Alternatively, this can be done organically or automatically during operation. In other words, if one pipe rotates relative to another pipe upon a torque input, such as through operation of a motor of the pump 22 described above, the pipes will only rotate until the anti-rotation apparatus engages.

Once the locking groove 76, or one of the locking grooves, in the spigot or male end, i.e., the first end 30 of the second pipe 24b is rotationally aligned with the stop piece 50, or one of the stop pieces, the stop piece may still not engage with the locking groove if the pipe joint 28 is under compression, as depicted in FIG. 10. Under compression, the base 54 of the stop piece 50 will still be biased radially outward in the deeper part D1. When the pipe joint 28 is placed under tension, as shown in FIG. 11, the stop piece 50 is drawn toward the shallower part D2 of the recess or groove 72. To help facilitate this, a chamfer 91 may be provided at the transition between the groove or recess surfaces S1 and S2, as shown in FIG. 7. The feet 58 of the base 54 will be forced into alignment with and engage the shallower surface S2 of the respective grooves or recesses 72 and thus the stop piece 50 will be moved radially inward into engagement with the locking groove 76. The base 54 of the stop piece 50 then resides in the locking groove 76 with the bottom surface 53 of the base 50 borne against or adjacent a groove bottom 92. The exposed ends on the feet 58 of the base 54 are seated between groove end walls 94 of the locking groove 76. See FIGS. 10-12. This arrangement captures the base 54 of the stop piece 50 between the groove end walls 94, which engages the anti-rotation apparatus and creates a lock or interference that prevents relative rotation of the pipes 24a and 24b.

The locking groove or grooves 76 in the pipe belled end 32 have the varying depth D1 and D1 to allow the stop piece to sit in two different positions, as noted above. While the stop piece is recessed in the deeper portion D1 of the grooves or recesses 72, it does not interfere with the spigot end 30, and the pipe joint 28 can be assembled or disassembled. The base 54 of the stop piece 50 is encouraged into the shallow depth D2 portion of the grooves or recesses 72 when the joint is put under tension, as in FIG. 11. This pushes the stop piece 50 into the aligned locking groove 76 on the spigot end 30 as soon as rotational alignment allows for it. When pipe joint 28 is not under tension, as in FIG. 10, the stop piece 50 can be manually positioned into their recessed state of the deeper portion D1 of the recesses or grooves 72 to allow for disassembly of the joint.

The stop piece 50 in this embodiment can again be formed of any suitable material, such as various plastic materials, as long as it can function as described above. The shape of the body 52, including the loop portion 56 of the stop piece 50 can also vary, as can the size, orientation, position, and type of loop. Likewise, the size, shape, and curvature of the base 54 can also vary according to the needs of a given application and use. The holes 70, recesses 72, and locking grooves 76 can thus also be modified accordingly to accommodate such modification and to function as intended.

The rotational alignment can be achieved from immediate assembly of the pipe joint or after the pipes are rotated relative to one another until the locking groove and stop piece align. Because of this, the bell/spigot joint can be assembled in any relative rotational alignment. The two pipes or joint parts can be manually rotated to engage the locking feature, or the rotation can be allowed to occur naturally or organically during use. Once engaged, the pipe joint components are prevented from further rotating relative to one another. See FIGS. 11 and 12. When engaged, the anti-rotation apparatus in this embodiment will inhibit or prevent the two pipes from being separated because the stop piece is forced into the locked or engaged position D2 within the grooves or recesses 72 with the joint under tension. Thus, the stop piece 50 may be removed, as described above, before the two pipes are separated.

The integrity of the pipe joint 28 in the lengthwise direction can be axially retained in any suitable manner, and independent of the anti-rotation apparatus 40 described and disclosed herein. The joint 28 is axially retained in the above described embodiment of FIGS. 2-12 using the patent owner's CERTA-LOK CLIC technology and components, which employ an automatic spline locking feature.

Briefly, a spline groove 100 is provided on the inner surface 74 of the belled end or second end 32 of the first pipe 24a. A squeezable retainer ring or spline 102 is seated in the spline groove 100 and has squeeze tabs 104 that can be used to manually expand the ring diameter. The squeeze tabs 104 protrude from an aperture 106 in the wall of the belled end or second end 32. A corresponding retainer groove 108 is provided on the outer surface 78 of the spigot or first end 30 of the second pipe 24b. The spline groove 100 and retainer groove 108, as well as the spline 102, are cooperatively shaped, as is known, so that the spline 102 automatically locks and axially retains the two pipes 24a and 24b in the engaged state once assembled. A seal 110, i.e., a gasket or O-ring, can also be seated in a seal groove 112, which may be provided on one of the joint parts, such as on the inner surface 74 of the belled second end 32 of the first pipe 24a. To release this axial retention mechanism of the pipe joint 28, the tabs 104 of the spline 102 can be squeezed together within the aperture 106. This expands the diameter of the spline 102, releasing it from the retainer groove 108, and permitting the pipes 24a and 24b to be pulled apart. The anti-rotation apparatus 40 would prevent separation of the two pipes 24a and 24b unless the stop piece 50 is removed, as discussed above.

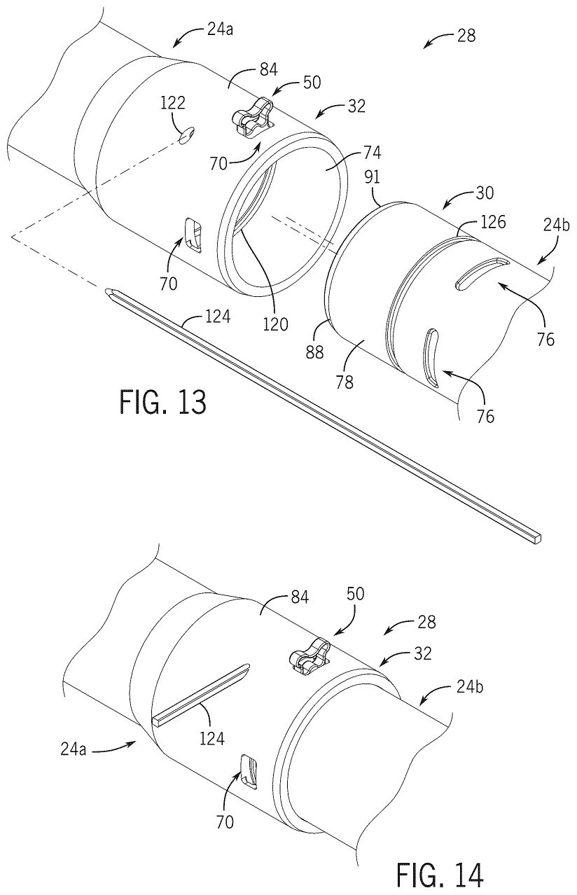

As shown in FIGS. 13 and 14, the pipe joint 28 can be axially retained using other methods. In one embodiment, the pipe joint 28 can be axially retained using the patent owner's CERTA-LOK spline technology and components, which are manually installed. Briefly, a spline groove 120 is again provided on the inner surface 74 of the belled end or second end 32 of the first pipe 24a. An opening 122 is provided through the wall of the belled second end 32 of the first pipe 24a and is aligned with the spline groove 120. An elongate, stiff but flexible spline 124 is also provided. A corresponding retainer groove 126 is again provided on the outer surface 78 of the spigot or first end 30 of the second pipe 24b. The spline groove 120 and retainer groove 126, as well as the spline 102, are again cooperatively shaped, as is known. When the two pipes 24a and 24b are assembled, the spline 124 is manually inserted through the opening 122 into the now axially aligned spline groove 120 and retainer groove 126. The spline 124 locks and axially retains the two pipes 24a and 24b in the engaged state. Though not shown in this embodiment, a seal, i.e., a gasket or O-ring, can also be seated in a seal groove, which may be provided on one of the joint parts. To release the pipe joint 28, an exposed tail of the spline 124, protruding outside the pipe joint 28 as shown in FIG. 11, can be forcibly pulled to withdraw the spline from the grooves 120 and 126. This eliminates the retention feature, permitting the pipes 24a and 24b to be pulled apart, as long as the stop piece 50 is also removed. The anti-rotation apparatus 40 again would prevent axial separation of the pipes 24a and 24b, as described above, unless it is removed. Still other joint retainer configurations may also be used, independent of the disclosed anti-rotation feature.

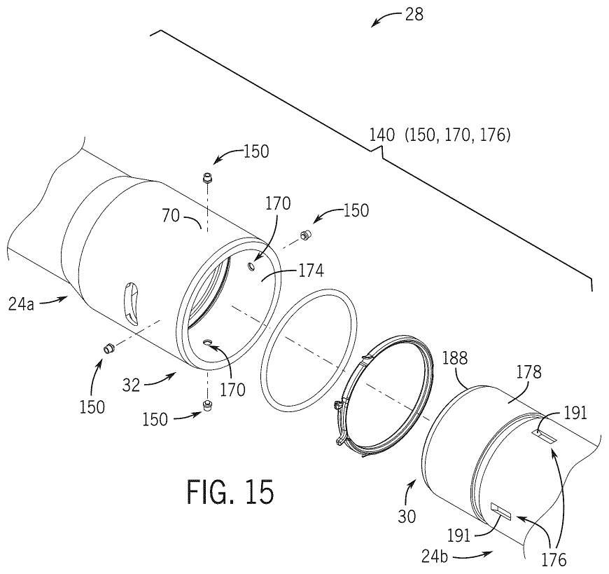

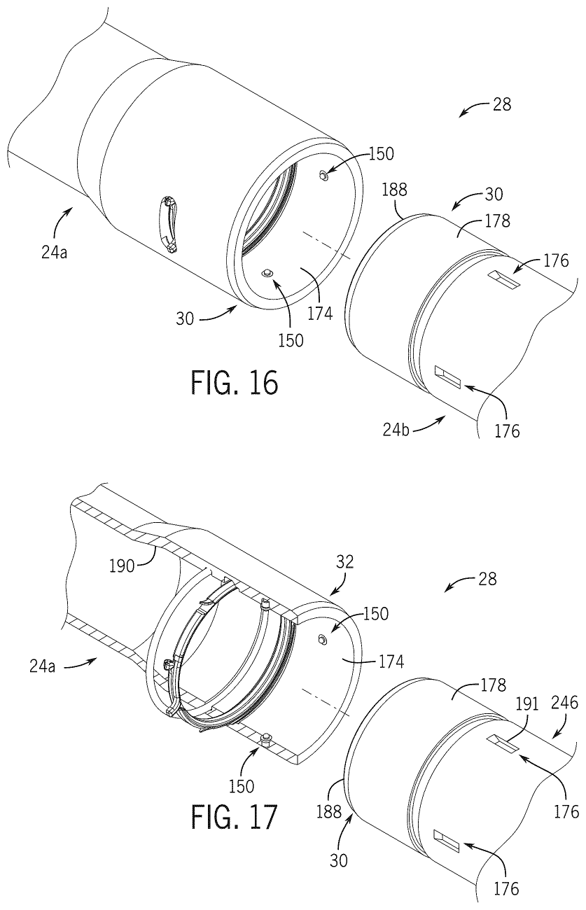

As noted above, the anti-rotation apparatus, including the stop piece, can vary in configuration and construction, as can other aspect of the anti-rotation apparatus. FIGS. 15-22 show another embodiment of an anti-rotation apparatus 140 for a pipe joint 28. Much of the pipe joint detail discussed above is not repeated below for the sake of brevity. However, numerous aspects of the above-described anti-rotation apparatus are equally applicable to this embodiment. In this embodiment, the anti-rotation apparatus includes a stop piece 150 or multiple stop pieces. Each has a locking part in the form of a spring ball-type protruding element.

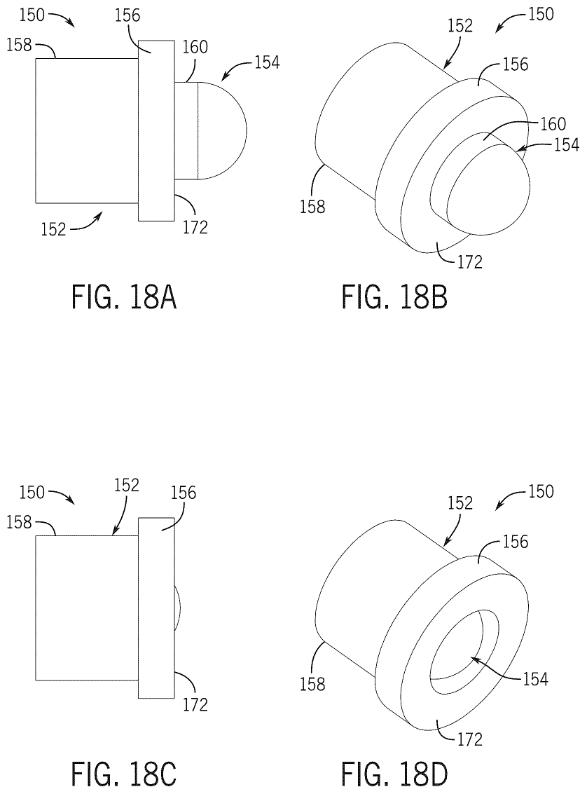

In this embodiment, each stop piece 150 has a retaining part, i.e., a body or housing 152, a spring (not shown) within a cavity or receptacle in the body or housing, and a locking part, i.e., a retractable locking ball or pin 154. The pin 154 is biased by the spring and projects outward from the body or housing 152. See FIGS. 18A-18D. The body or housing 152 can be any suitable shape but in this embodiment the housing has a cylinder shape, with a larger diameter shoulder or flange 156 disposed at the end from which the locking pin 154 projects. The housing 152 can be formed from a metal, a rigid plastic, a composite, or the like. The locking pin 154 can be elongate and have any suitable shape in cross section. The free end 158 of the locking pin is an engaging element and can be rounded, as shown, or can have a flat shape or other suitable locking shape.

In this embodiment, the pin 154 is cylindrical in shape matching the shape of the housing 152 and of the cavity in the housing. A proximal end, i.e., the hidden end, of the locking pin 154 is received inside the cavity or receptacle in the housing and is in contact with the spring. The other end, i.e., the free end 158 or locking end of the locking pin 154 projects from the housing 152. The free end 158 of the locking pin 154 can be rounded or chamfered in some way. The exposed portion of the pin 154, when extending from the housing 152, can include a segment 160 of the pin that is not rounded, i.e., that is a straight cylinder segment coupled to the rounded free end 158. The segment 160 can aid in creating the locking feature for the insert, as described below. The spring allows the locking pin 154 to be retracted into the housing 152 against the biasing force of the spring but otherwise biases the pin 154 outward from the housing 152. See FIGS. 18C and 18D. The housing 152 and the shoulder or flange 156 are configured to retain the stop piece 150 on the female end of the pipe or coupling, once installed, in this embodiment.

With reference to FIGS. 15-17 and 22, the anti-rotation apparatus again includes a receiving receptacle for installing and holding the stop piece. In this embodiment, the receiving receptacle is provided as one or more blind bores 170. Each blind bore 170 is formed into an inner surface 174 of the female end 32 of a pipe 24a. In this embodiment, the number of blind bores 170 may match the number of stop pieces 150 one for one and each for receiving a housing 152 of one of the stop pieces 150. If more than one stop piece 150 is used in this embodiment, the female end or second 32 of the first pipe 24a would include a blind bore for each stop piece. Alternatively, the female end 32 of the pipe 24a can include one or more alternate or optional holes or blind bores 70 for a single stop piece 150 or fewer stop pieces than blind bores. For the anti-rotation function, however, only one insert need be utilized.

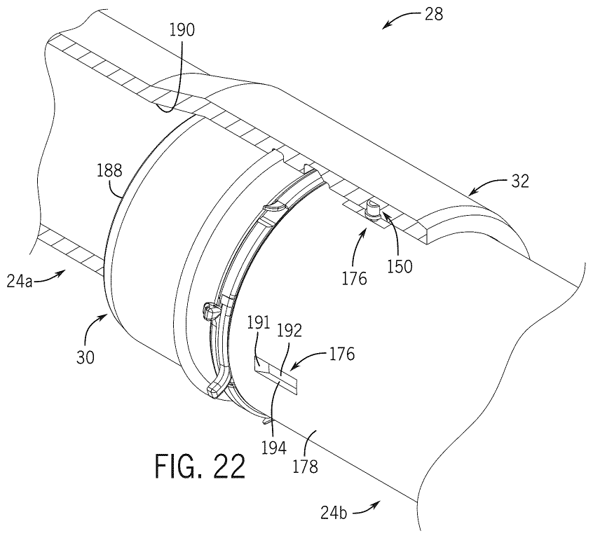

Once installed in a hole or bore 170, the housing 152 is recessed so that the end facing surface 172 of the shoulder or flange 156 is at least flush with or below the inner surface 174 of the female end of the one pipe 24a. Thus, in this embodiment, the holes or bores 170 each may have a deeper section having a diameter that matches the diameter of the housing shape and may have a larger diameter section adjacent the inner surface 174 of the female end 32 of the pipe 24a that matches the diameter of the flange 156. See FIGS. 15 and 22. The housing 152 size/shape and the hole or bore 170 size/shape may be configured so that the housing is press fit into the hole or bore and is held in place by surface contact or friction. Alternatively, the housing 152 may include surface features that aid in retaining the housing in the hole or bore 170 once installed or may be otherwise adhered, mechanically locked, threaded, or bonded to the surfaces of the bore.

The anti-rotation apparatus 140 also includes a locking receptacle that interact with the one or more locking pieces 150 to prevent relative rotation between the two connected pipes. The locking receptacle may again be provided on the male end 30 or spigot of the pipe 24b to be received in the female end 32 of the other pipe 24a. In this embodiment, the locking receptacle includes one or more blind grooves, i.e., locking grooves 176 recessed into an outer surface 178 of the pipe 24b. The locking grooves 176 are formed in this embodiment to extend in a lengthwise or axial direction along the pipe outer surface 178. If two or more grooves 176 are provided on the pipe, they are spaced apart circumferentially around the first end 30 of the pipe 24b. With one stop insert 150 and more than one locking groove 176, more than one anti-rotation landing spot is provided. Again, this will require less rotation between the female end 32 and the male spigot 30 before the stop piece 150 engages one of the grooves 176 to rotationally lock the two joint parts together. Alternatively, multiple stop pieces 150 and multiple locking grooves 176 can be provided in this embodiment to achieve the same purpose.

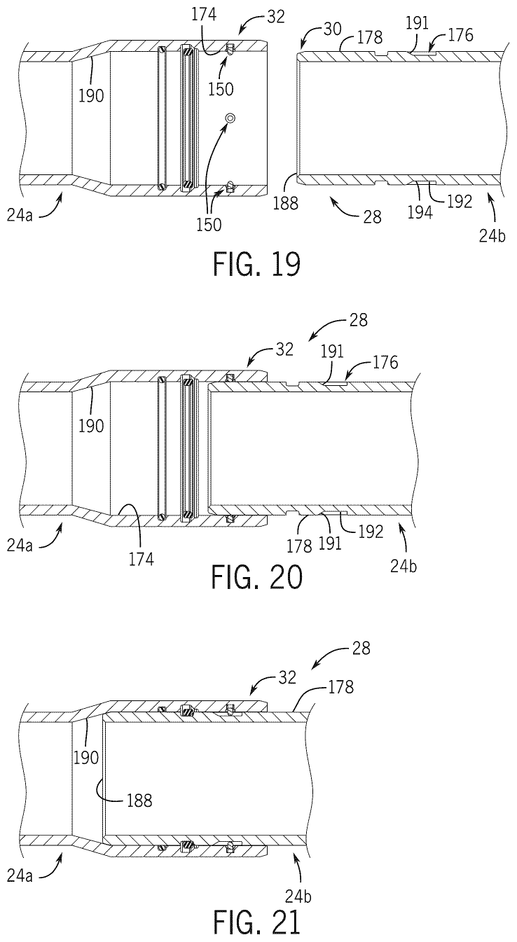

The stop piece 150 or pieces in this embodiment are installed by inserting the housing 152 into one of the blind bores 170 from the inside of the female end 32 of the pipe 24a. The housing 152 of the insert should be securely held in place. The locking pin 154, extended by the spring inside the housing 152, protrudes radially inward into the interior passage of the female end 32 of the pipe 24a. See FIG. 19. If one wanted to remove the insert, the insert would have to be pulled, via the pin, or pried, via the shoulder or flange, from the bore or hole.

With reference to FIGS. 19-22, the pipe joint 28 is formed by inserting the male end 30 or spigot of the pipe 24b into the female end 32 or belled end of the pipe 24a. See FIGS. 19 and 20. The free end 158 of the locking pin 154 is rounded or chamfered in this embodiment. A leading end 188 of the spigot end 30 of the pipe 24b may also be chamfered. The chamfered end 188 on the pipe 24a and the rounded free end 158 of the spring pin 154 allow the pipe 24a to compress the spring in the housing 152, retract the pin 154, and bypass the stop insert 150. See FIG. 20. When force is applied by the outer surface 178 of the pipe 24b to the locking pin 154 of the stop piece 150, the locking pin retracts into the housing 152 and thus relative to the inner surface 174 of the female end 32 of the first pipe 24a. This allows for insertion of the first or male end 30 of the second pipe 24b past the insert and to be fully installed into the belled end 32 of the first pipe 24a. Sec FIG. 21.

Once the locking groove 176 or grooves in the first end or spigot end 30 of the second pipe 24b are aligned in the axial direction with the stop piece 150, the anti-rotation feature is ready to engage. The axial insertion amount of the first end 30, i.e., the male end or spigot can again be designed to automatically set and align properly. This can be achieved by a precise length of the spigot end 30 of the second pipe 24b being received in the female or belled end 32 of the first pipe 24a before hitting a stop 190, such as the diameter reduction created by the bell shape on the inner surface 174 in the female end. See FIGS. 21 and 22. As noted above, it may be highly likely that, though axially aligned and ready to engage, the locking groove 176 or one of the grooves is not rotationally or circumferentially aligned with the stop piece 150 or pieces. Thus, the two pipes 24a and 24b must be rotated relative to one another.

Once the locking groove 176 grooves in the spigot or male end 30 of the second pipe 24b and the stop piece 150 or pieces are rotationally aligned, the spring biased locking pin 154 or pins can fire into the locking groove 176 or grooves until contacting a groove bottom 192. The exposed segment 160 of the locking pin 154 will engage with vertical lateral groove side walls 194 of the locking groove 176 to create interference and prevent further rotation of the pipes 24a and 24b relative to one another. The rotational alignment can be achieved from immediate insertion of the pipe 24b into the pipe 24a or after the pipes are rotated relative to one another until the locking groove 176 and the locking pin 154 of the stop piece 154 align. Because of this, the bell/spigot joint 28 can be assembled in any relative rotational alignment. The two pipes 24a and 24b can be manually rotated to engage the anti-rotation locking feature, or the rotation can be allowed to occur naturally or organically during use, as described above. Once engaged, the pipe joint 28 components will be further prevented from rotating relative to one another.

The locking groove 176 or grooves in the first pipe 24a belled end 32 can also have a chamfer or ramp 191 at one end, which is the leading end upon insertion and the trailing end upon removal of the second pipe 24b. This allows the locking pin 154 to be pushed into the housing, so that stop piece 150 does not interfere with the spigot or first end 30 as it is pulled from the belled end 32, and the pipe joint 28 can be assembled or disassembled without restriction.

The parts of the stop piece 150 in this embodiment can again be formed of any suitable material, such as various plastic materials, composite materials, steel, or other suitable materials or material combinations. The spring can be a conventional steel coil spring and the pin 154 can be a steel pin. The housing 152 can also be steel, plastic, composite, or the like. The materials can vary as long as the stop piece can function as described above. The size and shape of the housing and locking pin, and the size, shape, and type of spring within the housing, can also vary.

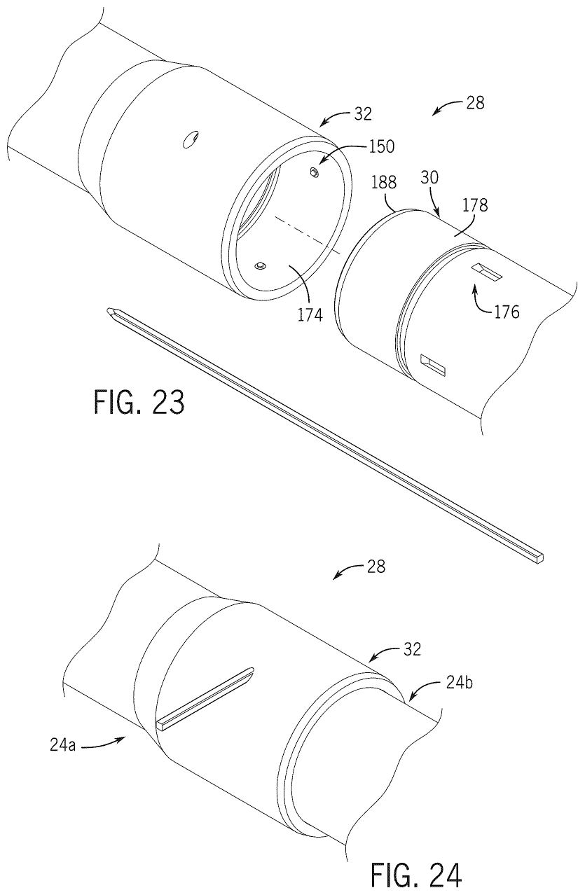

The integrity of the pipe joint in the lengthwise direction can again be axially retained in any suitable manner. The joint is retained in the embodiment of FIGS. 15-22 using the applicant's CERTA-LOK CLIC components, which employ an automatic spline locking feature, as described above. As shown in FIGS. 23 and 24, the pipe joint can be axially retained using the applicant's CERA-LOK spline that is manually installed. Again, other joint retainer configurations may also be used, independent of the disclosed anti-rotation feature.

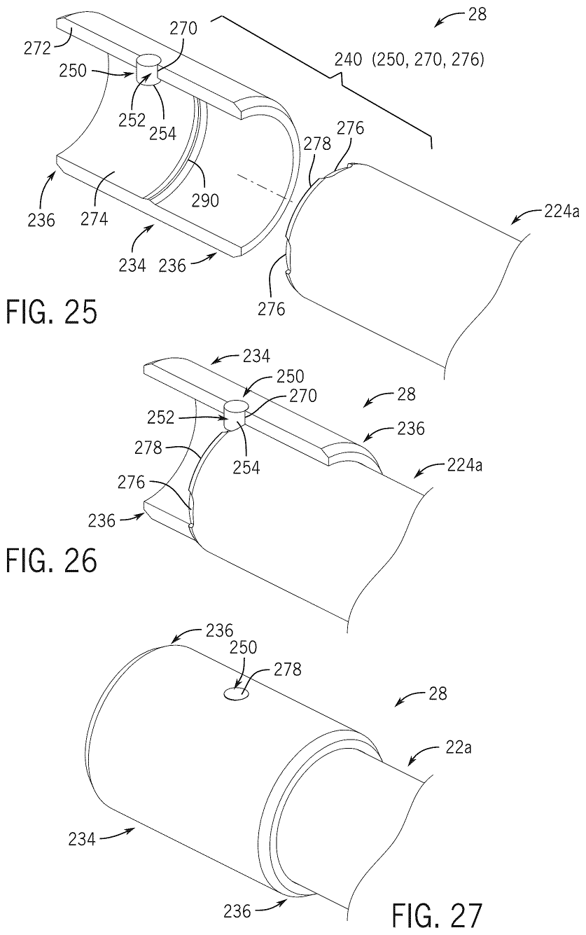

FIGS. 25-27 show simplified views of a pipe joint 28 that includes another embodiment of an anti-rotation apparatus 240. In this embodiment, the axial retainer components, such as the aforementioned spline and groove arrangements, and seal components, such as an O-ring, are not shown. However, the pipe joint 28 in this embodiment can include such components and features. In this embodiment, the pipe joint 28 has two pipes 224a (only one is shown) of the same diameter. The pipes 224a are joined to one another at the pipe joint 28 by a coupler 234 that has larger diameter, i.e., female openings, relative to the pipe diameters, at the ends 236 of the coupler. Use of a coupler between two pipes at a pipe joint is mentioned above as an optional pipe joint arrangement.

In this embodiment, the anti-rotation apparatus 240 includes a locking receptacle, a receiving receptacle, and a locking part, as in the embodiments described above. As shown in FIGS. 25 and 26, the receiving receptacle can be a hole or aperture 270 through a wall 272 in a first joint part, such as the coupler 234. In this embodiment, the hole or aperture 270 is positioned centrally in an axial direction of the coupler 234. The inner surface 274 of the coupler 234 can include a stop 290, such as an integral rib, which protrudes radially inward from the inner surface 274. The rib 290 can be positioned in axial alignment with the aperture or hole 270 for reasons as discussed below.

The locking receptacle in this embodiment includes one or more notches 276 formed in a free or distal end 278 of a second joint part, such as a spigot end 30 of the pipes 224a. A stop piece 250 in this example is a body 252 of a peg or dowel with a retaining part that is received and captured in the hole or aperture 270. The body 252 can vary in size and shape and still function as a rotation stop. In this example, the body 252 is cylindrical, but could also have a different shape in cross-section, such as a square or rectangle shape or a more complex shape, if desired. The locking part can be a stop portion 254 of the dowel or peg, i.e., the body 252 that protrudes radially inward from the inner surface 274 of the coupler 234 into the passage of the coupler. The retaining part, i.e., part of the body 252 captured in the hole 270, stop piece 250 can be secured in the hole or aperture 270 by any known manner, such as rotation or friction welding, mechanical threads, chemical or molecular bonding, friction, press fit, or the like.

As shown in FIGS. 25 and 26, the stop piece 250 is received in the aperture 270 in the coupler 234, with the stop portion extending into the coupler interior and axially aligned with the rib or stop 290. The pipes 224a can be inserted into the ends 236 of the coupler 234. The stop portion 254 will contact either the distal free end 278 of the pipes 224a or the notches 276, depending on rotational alignment. The pipes 224a can be rotated as needed so that the stop portion 254 seats in one of the notches 276. Once seated, the pipes 224a can be retained axially as noted above and the stop portion 254 and notch 276 will prevent further rotation between the two pipes 224a and the coupler 234.

In other embodiments, more than one hole or aperture and more than one stop piece 250 can be utilized. Also, multiple notches 276 can be provided in the free edge 278 of the pipes 224a to provide more than one landing spot for the stop piece(s). Also, the pipes can carry the apertures and the stop pieces, and the coupler can carry the notches, or the anti-rotation apparatus 240 can be applied to two pipes, as described above, with no intervening coupler. To disassemble the pipe joint in this example, the anti-rotation apparatus need not be removed or otherwise altered, once installed. Only the axial retention features need be removed or detached. The interference created by the anti-rotation apparatus 240 prevents relative rotation between the two pipes 224a, but the spigot ends 30 can be removed normally from the coupler 234 for joint disassembly.

Other variations and modifications to the anti-rotation apparatus components are certainly possible within the spirit and scope of the present disclosure. The various recess and groove shapes, sizes, dimensions, and quantity can be changed. The receiving receptacle may include only a single hole, and the locking part may include only one stop piece. Other variations and modifications to the receiving and locking receptacles and the stop piece are also possible. Further, any pipe joint described herein can be configured at least in part on a pipe, a pipe coupler, or a component to which a pipe or coupler might be attached, such as a pump or motor or a component at a well head. It should be understood that any one of the features, aspects, characteristics, components, arrangements, and the like may be utilized, alone or in any combination with any of the disclosed embodiments and with any other of the features, aspects, characteristics, components, arrangements, and the like.

Although certain anti-rotation apparatus and method embodiments, and pipe assembly and system embodiments, have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. An anti-rotation apparatus for a pipe joint, the apparatus comprising:
a stop piece having a body with a retaining portion and a locking part;
a first joint part and a second joint part coupled to one another and having an axis in a lengthwise direction of the pipe joint;
a locking receptacle provided in the first joint part; and
a receiving receptacle provided in the second joint part,
wherein the retaining portion of the body of the stop piece is disposed in the receiving receptacle of the second joint part,
wherein the locking part protrudes in a radial direction relative to the axis, and
wherein, when the locking part and the locking receptacle are axially and rotationally aligned, and when the locking part is disposed in the locking receptacle of the first joint part, relative rotation about the axis between the first joint part and the second joint part is prevented.

2. The anti-rotation apparatus of claim 1, wherein the first joint part is a spigot end of a first pipe, wherein the second joint part is a belled end of a second pipe, wherein the spigot end is disposed in the belled end, and wherein the axis is a center axis of the first and second pipes.

3. The anti-rotation apparatus of claim 1, wherein the receiving receptacle comprises a blind bore in or a hole through a wall of the second joint part.

4. The anti-rotation apparatus of claim 1, wherein the receiving receptacle comprises a plurality of blind holes in or a plurality of through holes through a wall of the second joint part, and wherein the plurality of holes is spaced apart from one another circumferentially about the axis.

5. The anti-rotation apparatus of claim 4, wherein the plurality of blind or through holes is spaced apart equidistant from one another on the second joint part.

6. The anti-rotation apparatus of claim 1, wherein the locking receptacle comprises a locking groove in an outer wall of the first joint part.

7. The anti-rotation apparatus of claim 6, wherein the locking groove has a finite length and extends in a circumferential direction on the first joint part, and wherein the finite length is adequate to receive the locking part of the stop piece therein.

8. The anti-rotation apparatus of claim 6, wherein the locking receptacle comprises a plurality of the locking grooves arranged circumferentially around the first joint part.

9. The anti-rotation apparatus of claim 1, wherein the body of the stop piece comprises:
a base having a base length across the stop piece between opposed ends, at least a portion of the base defining the locking part; and
a loop portion protruding from a top surface of the base, at least part of the loop portion defining the retaining portion.

10. The anti-rotation apparatus of claim 9, wherein:
the loop portion defines and surrounds an open center within the loop portion;
the loop portion defines a pair of retention ears at a free end of the loop portion spaced from the base,
the loop portion has a first width across the retention ears of the loop portion, the first width being less than the base length;
the loop portion has a midsection between the base and the pair of retention ears; and
the loop portion has a second width across the dissection, the second width being less than the first width.

11. The anti-rotation apparatus of claim 9, wherein the loop portion is resiliently flexible.

12. The anti-rotation apparatus of claim 1, wherein:
the receiving receptacle includes a hole through a wall of the second joint part;
a dual depth recess is provided in the wall on each side of the hole in the circumferential direction; and
the locking part is movable in a radial direction relative to the axis according to the dual depth recess.

13. The anti-rotation apparatus of claim 1, wherein the body of the stop piece comprises:
a housing containing a biasing element therein, the housing defining at least part of the retaining portion; and
a pin resiliently biased to protrude from the housing, the pin being retractable into the housing and defining at last a portion of the locking part.

14. The anti-rotation apparatus of claim 1, wherein the first joint part is a spigot end of a first pipe, wherein the second joint part is a coupler with an opening configured to receive the spigot end of the first pipe, wherein the spigot end is disposed in the opening, and wherein the axis is a center axis of the first pipe and the coupler.

15. A method of forming a pipe joint having an anti-rotation feature and an axis, the method comprising:
providing a first joint part having one or more locking receptacles formed in the first joint part;
installing a retaining portion of a body of a stop piece into a receiving receptacle of a second joint part, whereby a locking part of the body protrudes inward from an inner surface of the second joint part in a radial direction;
inserting the first joint part into the second joint part; and
when the locking part is not yet engaged with the any of the one or more locking receptacles, facilitating rotation of the first joint part and the second joint part relative to one another until the locking part axially and rotationally aligns with and engages one of the one or more locking receptacles, thereby preventing relative rotation about the axis between the first joint part and the second joint part.

16. The method of claim 15, wherein:
the body of the stop piece includes
a base having a base length across the stop piece between opposed ends, at least a portion of the base defining the locking part, and
a loop portion protruding from the base, at least part of the loop portion defining the retaining portion;
the step of installing includes installing the loop portion through the receiving receptacle;
the step of inserting includes the outer surface of the first joint part forcing the locking part radially outward within the receiving receptacle; and
placing the first joint part and the second joint part under tension, causing the locking part of the stop piece to engage the locking receptacle.

17. A pipe joint assembly comprising:
a first pipe having a first pipe first end and a first pipe second end, the first pipe first end defining a spigot end of the first pipe;
a second pipe having a second pipe first end and a second pipe second end, the second pipe second end defining a belled end of the second pipe, the spigot end of the first pipe inserted into the belled end of the second pipe; and
an anti-rotation apparatus configured to prevent relative rotation between the first pipe and the second pipe,
wherein the anti-rotation apparatus includes a stop piece installed in a radial direction in a wall of the belled end of the second pipe, and
wherein a locking part of the stop piece is received in a locking receptacle in an outer surface of a wall of the spigot end of the first pipe.

18. The pipe joint assembly of claim 17, wherein the body of the stop piece comprises:
a base having a base length across the stop piece between opposed ends, at least a portion of the base defining the locking part; and
a loop portion protruding from a top surface of the base, at least part of the loop portion defining the retaining portion.

19. A drop pipe system comprising:
a pump configured to be installed below ground;
at least one power cord configured to extend from above ground level to the pump below ground level and to deliver power for operating the pump;
a pipe string including a plurality of pipes, the pipe string having one end connected to the pump and another end accessible near ground level;
a first pipe of the plurality of pipes having a first pipe first end and a first pipe second end;
a second pipe of the plurality of pipes having a second pipe first end and a second pipe second end, the first pipe first end connected to the second pipe second end to form a pipe joint; and
an anti-rotation apparatus at the pipe joint configured to prevent relative rotation between the first pipe and the second pipe when the pump is operated,
wherein the anti-rotation apparatus includes a stop piece installed in a radial direction in a wall of the pipe joint, and
wherein a locking part of the stop piece is received in a locking receptacle in an outer surface of another wall of the pipe joint.

20. The pipe joint system of claim 19, further comprising a coupler between and connecting the first pipe first end to the second pipe second end.
